(19) United States
(12) Patent Application Publication
(10) Pub. No.: US 2005/0129204 A1
(43) Pub. Date: Jun. 16, 2005

(54) Audio intercom with stacklight indication system and method

(75) Inventors: Angelo Arcaria, Wethersfield, CT (US); Ray LeBlanc, Bristol, CT (US); Kenneth R. Taylor, Ivoryton, CT (US)

Correspondence Address: BAKER & HOSTETLER LLP;Washington Square, Suite 1100, 1050 Connecticut Avenue, N.W., WASHINGTON, DC, 20036, US

(73) Assignee: Edwards Systems Technology Inc.

(21) Appl. No.: 10/734,283

(22) Filed: Dec. 15, 2003

(51) Int. Cl. H04M 1/60; H04M 9/00

(52) U.S. Cl. 379/167.01

(57) ABSTRACT

A communication system and method of communicating are provided. The communication system includes an intercom unit having a housing, a plurality of lights attached to the housing, a speaker connected to the housing, a microphone connected to the housing and an activator connected to the housing and configured to activate the microphone. The system further includes a controller configured to communicate with the intercom unit and at least one additional intercom unit. A method of communicating includes sending an audio signal over an intercom system wherein the intercom system, comprises a plurality of intercom units having a plurality of signal lights connecting the signal lights to sensors associated with the equipment that is not associated with the intercom system and configuring the signal lights to indicate operating characteristics of the equipment and controlling the intercom system with the controller.

### FIELD OF THE INVENTION

The present invention relates generally to a communication system. More particularly, the present invention relates to an audio intercom in combination with a stacklight indication system.

### BACKGROUND OF THE INVENTION

Industrial areas such as factory floors often have signaling devices located near or in the proximity of operating machinery. These signaling devices are connected to the machinery and are configured to indicate the operating status of the machinery. For example, a red light may indicate the machine is not operating. Other lights may indicate other conditions.

Studies of signaling devices used in industrial areas show that effecting warning, alerting, and communication are best accomplished by devices that can communicate by multiple methods. For example, communication via light indications can include strobe lights, incandescent, halogen, or LED light sources mounted in a stacked configuration. In addition to a light signaling device, an audio speaker or intercom system may also be desirable for communicating with workers located on the factory floor or in industrial areas. In industrial applications, a device may be needed to communicate in areas that have a high ambient noise level, or in areas where the noise level is changing because of equipment or because of a process continuously starting and stopping. In such applications, a visual beacon and tone/voice alert combination may be more likely to call attention to an emergency or equipment malfunction rather than a discrete visual tone or voice signal.

In addition, it is often desirable to communicate with workers associated with a communication system, and/or give alerts to all workers or to communicate with a specific individual worker. Also, it may be desirable for that worker to communicate with the central control system. For example, the worker may give reports of a machines or a piece of equipment operating status, output, or other type of parameter.

Accordingly, it is desirable to provide a method and apparatus that is able to give both visual and audio signals and also to provide a communication system for communicating with equipment operators in industrial areas.

### SUMMARY OF THE INVENTION

The forgoing needs are met, to a great extent, by the present invention, where in one aspect an apparatus is provided that in some embodiments include a system of communication that provides both visual and audio signals. In other embodiments of the invention, an audio communication system is provided that, in some embodiments, may communicate system wide or with individual portions of the system.

In accordance with one embodiment of the invention, an intercom unit is provided. The intercom unit includes: a housing, a plurality of signal lights attached to the housing, a speaker connected to the housing, a microphone connected to the housing, and an activator connected to the housing and configured to activate the microphone.

In accordance with one embodiment of the present invention, a communication system is provided. The communication system includes an intercom unit comprising: a housing, a plurality of signal lights attached to the housing, a speaker connected to the housing, a microphone connected to the housing, and an activator connected to the housing and configured to activate the microphone. The system, in addition to the intercom unit, further includes a controller configured to communicate with the intercom unit.

In accordance with another embodiment of the present invention, a communication system is provided. The communication system comprises an intercom unit comprising a means for housing, light emitting signaling means attached to the housing means, means for emitting sound connected to the housing means, means for inputting sound connected to the housing means, and means for activating connected to the housing means and configured to activate the sound inputting means. The communication system further includes, means for controlling the system configured to communicate with the intercom unit.

In accordance with another aspect of the present invention, a method of making a communication system is provided. The method includes providing an intercom system having a plurality of intercom units, integrating intercom units with a plurality of signal lights, and adapting one of the signal lights to indicate how a piece of equipment not part of the intercom system is functioning.

In accordance with another embodiment of the invention, a method of communicating is provided. The method includes sending an audio signal over an intercom system wherein the intercom system has a plurality of intercom units having a plurality of signal lights, connecting the signal lights to sensors associated with equipment not associated with the intercom system and configuring the signal lights to indicate operating characteristics associated with the equipment, and controlling the intercom system with a controller.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a communication system according to a preferred embodiment of the invention.

FIG. 2 is a schematic of an intercom unit in accordance with one embodiment of the invention.

FIG. 3 is a schematic of an intercom unit in accordance with a second embodiment of the invention.

### DETAILED DESCRIPTION

The invention will now be described with reference to the drawing figures in which like references will refer to like parts throughout. An embodiment in accordance with the present invention provides a communication system having an intercom unit which includes a plurality of signal lights associated with the intercom unit. Another embodiment of the invention includes a method of making a communication system that includes providing an intercom system, having a plurality of intercom units, integrating the intercom units with a plurality of signal lights and adapting the signal lights to indicate how a piece of equipment that is not part of the intercom system is functioning. A further embodiment of the invention includes a method of communicating that includes sending an audio signal over an intercom system, wherein the intercom system includes a plurality of intercom units having a plurality of signal lights. The signal lights are connected to sensors associated with equipment that is not associated with the intercom system and configured to indicate operating characteristics associated with the equipment in controlling the intercom system with a controller.

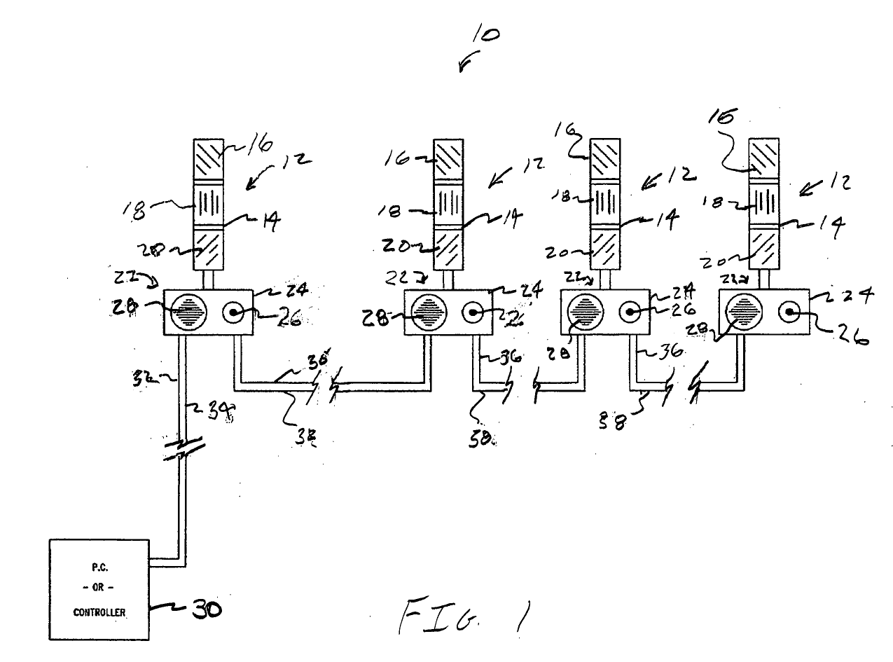

An embodiment of the present inventive apparatus is illustrated in FIG. 1. FIG. 1 shows a communication system 10. The communication system 10 includes a plurality of intercom units 12. The intercom unit 12 includes a stacklight 14. In the embodiment shown in FIG. 1, the stacklight 14 includes a first light 16 and second light 18 and a third light 20. Other embodiments of the invention may include more or less lights than the three lights shown in the stacklight 14. The stacklights 14 are used to indicate the status of a piece of equipment, such as an equipment on a factory floor. The stacklights 14 are connected to sensors associated with that equipment and give an indication of the operating status of the equipment. For example, if the equipment is functioning properly, the stacklight 14 may illuminate a green light. If the equipment is malfunctioning, the stacklight 14 may illuminate a red light. If there is a minor problem, the stacklight 14 may illuminate an amber colored light. Other light schemes may be used according to the specific needs of an individual installation.

Associated with the stacklight 14 is an audio portion 22. The audio portion 22 has a housing 24. The housing 24 contains a call button 26. The call button 26 allows an operator who wants to speak through the audio system 10 to communicate with another audio portion 22. The operator presses the call button 26 which will cause a microphone 28 to activate and allow the operator to speak into an intercom unit 12 and be heard throughout the system 10.

The housing 24 houses a speaker 28 which is configured to allow the operator of the intercom unit 12 to hear audio signals that are broadcast throughout the system 10 or sent to that specific intercom unit 12. In some embodiments of the invention the speaker 28 converts into a microphone 28 when the call button 26 is activated. Thus, in some embodiments, the speaker 28 and the microphone 28 are the same element but acts as a microphone or speaker depending on how it is operated.

In some embodiments of the invention, the system 10 is controlled by a system controller 30. The system controller 30 may be a personal computer or other type of controller, such as a micro-controller. The system controller 30 is connected to the intercom units 12 by connections 32 and 34. In some embodiments of the invention, the system controller 30 and the intercom units 12 are connected by a wireless connection. The intercom units 12 are connected to other intercom units 12 by connections 36 and 38. In some embodiments of the invention, the intercom units 12 may be connected to each other via wireless connections.

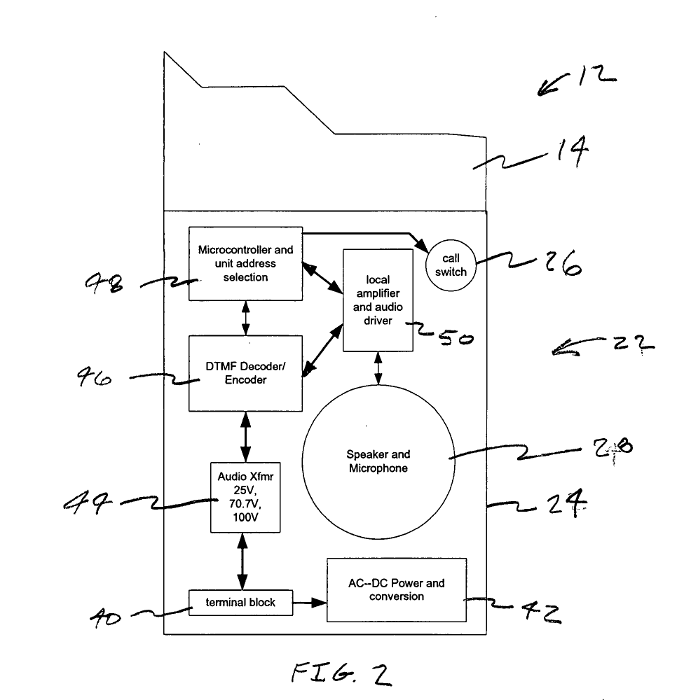

FIG. 2 is a schematic diagram of the audio components contained within the audio portion 22 of the intercom unit 12. The audio portion 22 is contained within a housing 24. Mounted on top of the housing 24 is a stacklight 14. A terminal block 40 is located within the housing 24 and is configured to receive power from an external power source. From the terminal block 40, the power is sent to an AC/DC power conversion unit 42 where the power received from the terminal block 40 is converted to DC if the audio units are configured to run DC power or convert to an appropriate AC voltage, depending on how the audio components are configured to run. The power is then sent from the AC/DC power conversion unit 42 to the components that require power.

Within the terminal block 40 there is a receiver for the audio signal received from either the controller 30 or other intercom units 12. The audio signal is inputted into the terminal block 40 and transferred to the audio transformer 44. In preferred embodiments of the invention, the audio signal can be 25 volt, 70.7 volt, 100 volt or can range thereinbetween. Other embodiments of the invention may use audio signals and other voltages. From the audio transformer 44, the audio signal is sent to the dual tone multi-frequency (DTMF) decoder/encoder 46.

In preferred embodiments of the invention, the type of audio signal that is inputted into the terminal block 40 is a two-toned analog signal. Two tones of different frequency are transmitted over two audio wires or in case of wireless type systems, two-tones of different frequency are transmitted to the terminal block 40. The DTMF decoder/encoder 46 takes the two different frequency analog tones and converts them into a digital digit. This digital digit is then inputted into a controller 48, which can be a micro-controller. In the embodiments of the invention that are not equipped with micro-controllers 48, the digital signal may be decoded by other digital means.

In preferred embodiments of the invention having a micro-controller 48, the micro-controller 48 is equipped with an individual address. The purpose of the address is to allow the micro-controller 48 to determine whether a specific tone should be broadcasted through the speaker of the intercom unit 12.

In preferred embodiments of the invention, the controller 48 is a micro-controller 48 and has an individual address for each intercom unit 12. The address is configured within the micro-controller 48 itself or in other embodiments of the invention, the address may result from the positions of several dip switches located on the intercom unit 12. In either event, the individual address for each intercom unit 12 may be manipulated by the dip switches or changed when it is stored in the micro-controller 48. In embodiments using the micro-controller 48, the system controller 30 can configure the micro-controller 48 to change its individual address.

In preferred embodiments of the invention, the DTMF decoder 46 is also an encoder. The local amplifier 50 is also an audio driver and the speaker 28 is also a microphone. In other embodiments of the invention the DTMF decoder may simply be a DTMF decoder and a separate component is used as an encoder. The local amplifier may simply be an amplifier and a separate unit is used as an audio driver and the speaker may simply be a speaker and a separate unit is used as a microphone.

The speaker 28 can also be configured as a microphone and the local amplifier 50 can also be configured as a audio driver and the DTMF decoder 46 can also be configured as an encoder. The micro-controller 48 also controls the DTMF decoder/encoder 46, the local amplifier/audio driver 50, and the speaker/microphone 28 to determine whether these components 46, 50 and 28 should act as an encoder or a decoder, an amplifier or audio driver, and a speaker or a microphone, respectively.

Call switch 26 is used to aid the micro-controller 48 in determining which mode these components 46, 50 and 28 should operate in a call. When the call switch 26 is activated, it sends a signal to the micro-controller 48, which converts the speaker/microphone 28 into microphone mode, the local amplifier and audio driver 50 into audio driver mode, and the DTMF decoder/encoder 46 into encoder mode. The call switch 26 is activated by the operator of a specific intercom unit 12 when the operator wants to input audio signals into the microphone 28. (For example, the operator wants to speak into the microphone 28.) The operator activates the call switch 26 by pressing the button and speaking into the microphone 28. The microphone 28 picks up the audio tones and voice from the operator and inputs those audio tones into the audio driver 50. The audio driver 50 then inputs the audio tones into the micro-controller 48 where the micro-controller determines whether the audio tone should be broadcasted to the entire system 10 or simply to the system controller 30. Alternatively, if the units 12 do not have a controller 48, the audio driver 50 could directly input the audio tones into the DTMF decoder/encoder 46. DTMF decoder/encoder takes the signals from the audio driver 50, transforms the digital signal into two audio tones of different frequencies and inputs those signals into the audio transformer 44. The audio transformer 44 then inputs the signals into terminal block 40 where they are transmitted through audio connections to either the controller 30, through the entire system including the controller 30 and the other intercom units 12 or through selected units 12 and the system controller 30.

The system 10 is configured through the system controller 30 to send audio signals only to specific intercom units 12 or send and broadcast through all of the intercom units 12. Optionally, the audio tones can be produced by a selected group of unit 12. Thus, the micro-controller 48 determines, based on its specific address, whether a tone should be broadcasted or ignored by a specific intercom unit 12. If the tone is to be broadcasted by a specific unit 12, micro-controller 48 then inputs the digitized audio signal into the local amplifier and audio driver 50. The local amplifier 50 amplifies the digital tone and inputs into the speaker/microphone 28 where the microphone 28 broadcasts the audio tones.

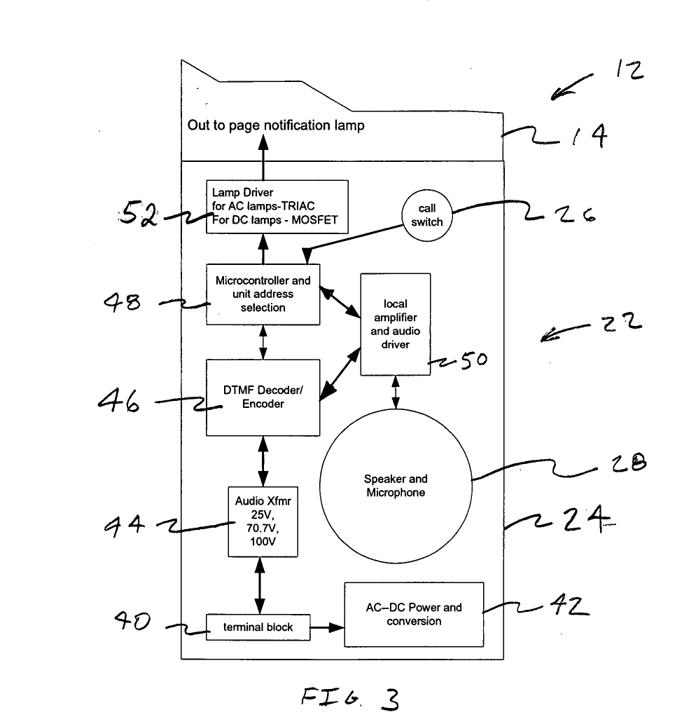

FIG. 3 is a schematic diagram of the audio components of an intercom unit 12 according to a second preferred embodiment of the present invention. The intercom unit 12 shown in FIG. 3 is similar to the intercom unit 12 shown in FIG. 2. In the embodiment shown in FIG. 3, intercom unit 12 has a terminal block 40, an AC/DC power conversion unit 42, an audio transformer 44, a DTMF decoder/encoder 46, a micro-controller and unit address selection 48, call switch 26, a local amplifier and driver 50, a lamp driver 52, and a speaker and microphone 28 contained within the housing 24.

One difference between the intercom unit 12 of FIG. 3 and the intercom unit 12 of FIG. 2 is the addition of a lamp driver 52 connected to the micro-controller 48. The lamp driver 52 is operably connected to one of the lights in the stacklight 14. The lamp driver 52 is configured and arranged so that when the micro-controller 48 detects an incoming audio signal configured to be broadcasted to that particular intercom unit 12, the micro-controller 48 sends a signal to the lamp driver 52. The lamp driver 52 then illuminates one of the lamps in the stacklight 14. Because the manufacturing facility can be very loud, it may be difficult for an equipment operator to hear an audio signal given off by the intercom unit 12. Thus, illuminating a lamp on the stacklight 14 will alert an equipment operator that an incoming audio signal is being received. If the lamps in the stacklight 14 are configured to use AC current, then the lamp driver 50 is a TRIAC configuration. TRIAC is a three dimensional device that controls and conduct current flow during both alternation of the AC cycle. If the lamps in the stacklight 14 are configured to use DC current, then the lamp driver 50 uses MOSFET (metal-oxide semiconductor field effect transistor) type configuration.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An intercom unit comprising:
a housing;
a plurality of signal lights attached to the housing in a stacklight configuration;
a speaker connected to the housing;
a microphone connected to the housing; and
an activator connected to the housing and configured to activate the microphone.

2. The intercom unit of claim 1, wherein at least some of the signal lights are operatively connected to an external equipment and are configured to indicate operating characteristics of the equipment.

3. The intercom unit of claim 1, wherein at least one signal light is configured to indicate an audio signal that is at least one of received and transmitted by the intercom unit.

4. The intercom unit of claim 1, wherein the intercom unit further comprises at least one of an amplifier for amplifying a signal input to the speaker and an audio driver configured to process a signal received from the microphone.

5. The intercom unit of claim 1 further comprising:
a dual tone multi-frequency decoder configured to convert an analog signal to a digital signal; and
a microcontroller operatively connected to the decoder and configured to receive the digital signal and input a signal to the speaker.

6. The intercom unit of claim 5 further comprising a lamp driver operatively connected to the microcontroller and configured to selectively operate one of the signal lights.

7. The intercom unit of claim 5, wherein the microcontroller has a distinct address.

8. The intercom unit of claim 5, wherein the decoder is also an encoder.

9. The intercom unit of claim 5, wherein the actuator is operatively connected to the microcontroller and configured to, when activated, cause at least one of: the speaker to convert to a microphone, an amplifier to convert to an audio driver, and the decoder to convert to an encoder.

10. The intercom unit of claim 1, wherein the intercom unit has a unique address that is changeable by at least one of: operating dip switches on the intercom unit, and operating a controller to alter an address associated with a microcontroller located in the intercom unit.

11. The intercom unit of claim 1, wherein the housing is comprised of a polycarbonate.

12. The intercom unit of claim 1, wherein the signal lights are configured to display light of differing colors.

13. The intercom unit of claim 12, wherein the signal lights display differing colors by illuminating different lights.

14. A communication system comprising:
an intercom unit comprising:
means for housing;
light emitting signaling means attached to the housing means;
means for emitting sound connected to the housing means;
means for inputting sound connected to the housing means; and
means for activating connected to the housing means and configured to activate the sound inputting means;
means for controlling the system configured to communicate with the intercom unit.

15. A method of making a communication system comprising:
providing an intercom system comprising a plurality of intercom units;
integrating the intercom units with a plurality of signal lights; and
adapting one of the signal lights to indicate how an equipment that is not part of the intercom system is functioning.

16. The method of claim 15, further comprising configuring a signal light to indicate when an intercom unit is receiving an audio signal.

17. A method of communicating, comprising:
sending an audio signal over an intercom system, wherein the intercom system comprises a plurality of intercom units having a plurality of signal lights;
connecting the signal lights to sensors associated with an equipment not associated with the intercom system and configuring the signal lights to indicate operating characteristics of the equipment; and
controlling the intercom system with a controller.

18. The method of claim 17, further comprising:
connecting a signal light to a intercom unit to indicate when the intercom unit is receiving an audio signal.

19. A communication system comprising:
an intercom unit comprising:
a housing;
a plurality of signal lights attached to the housing;
a speaker connected to the housing;
a microphone connected to the housing; and
an activator connected to the housing and configured to activate the microphone;
a controller configured to communicate with the intercom unit.

20. The intercom unit of claim 19, wherein the controller is configured to communicate by an audio signal.
